(19) United States
(12) Patent Application Publication
(10) Pub. No.: US 2008/0129037 A1
(43) Pub. Date: Jun. 5, 2008

(54) Tagging items with a security feature

(75) Inventors: Joseph D. Roth, Springboro, OH (US); John B. Holz, Natick, MA (US)

Correspondence Address: Christopher P. Ricci;Intellectual Property Section, Law Department, NCR Corporation, 1700 South Patterson Blvd., Dayton, OH, 45479-0001, US

(73) Assignee: Prime Technology LLC

(21) Appl. No.: 11/607,705

(22) Filed: Dec. 1, 2006

(51) Int. Cl. G06K 9/00; G06Q 30/00

(52) U.S. Cl. 283/85; 340/572.1; 235/375; 705/64

(57) ABSTRACT

A method and system for tagging an item with a security feature to allow subsequent authentication of the item. The system includes a secure reader for reading both a unique code on an item, such as a barcode, and a security feature applied to the item. The system may be used with a batch of security features for individual application to the item to tag the item. A database is also provided for storing for each tagged item details of (i) the unique code on the item, and (ii) the security feature for that tagged item.

The present invention relates to tagging items with a security feature.

### BACKGROUND

Security features are used to reduce or prevent counterfeiting of items. These items may have a high intrinsic value, such as banknotes, or they may be critical parts in other items, such as brake pads in fighter planes. By tagging an item with a security feature, the authenticity of the item can be verified by validating that the security feature is genuine.

Many different types of security feature are available, including: printed patterns, color shifting inks, chemical/biochemical markers, fluorescent fibers, fluorescent inks and coatings, photochromic inks, watermarks, thermochromic inks, holograms, and the like.

One disadvantage of conventional security features is that counterfeiters can spend a large amount of time and money to replicate a particular security feature, and can then use the replicated security feature on counterfeited items. When this occurs, the owner of the items may either change the security feature or add more security features, but neither of these actions can safeguard items that have already been issued with the now compromised security feature.

This is a fundamental problem with even the most advanced security feature.

### SUMMARY

According to a first aspect of the present invention there is provided a method of tagging an item with a security feature, the method comprising: selecting one of a plurality of different security features from a common type of security feature; applying the selected security feature to an item to create a tagged item; identifying a code associated with the tagged item; and associating the identified code with the selected security feature in an authentication database to ensure that the tagged item is only authenticated if the identified code matches the selected security feature.

Identifying a code associated with the item to be tagged may be performed by reading a spatial code, such as a barcode, associated with the item. The spatial code may be fixed to the item or may subsequently be applied to the item. The code may be read by a combined reader that is capable of reading both the code and the security feature.

The code may be printed on top of the security feature. Both the code and the security feature may be disposed on a label that can be attached to the item.

The code associated with an item to be tagged may comprise all or part of a spatial code.

This aspect of the invention is particularly advantageous where identical items have different spatial codes applied to them. For example, some manufacturers apply 2D barcodes to their products, where the 2D barcode includes a unique serial number for each product. 2D barcodes can store thousands of characters, which is much more information than conventional UPC barcodes can store, so identical processors from the same manufacturer can have slightly different 2D barcodes.

It will be appreciated that multiple different security features may all be of a common type. As a simple example, a type of security feature may be a geometric shape, and individual security features of this type may be a circle, a square, a triangle, and the like. Thus, the security features (the individual shapes) are all different, but they are all instances of the same type of security feature (a geometric shape). Where the type of security feature is a luminophore, one security feature may have one luminescence spectrum, another security feature may have a different luminescence spectrum, and so on. Each of these security features being an instance of the luminophore type (or class) of security feature.

As used herein a “luminophore” is a luminescing substance that may be in the form of a pigment applied to an ink, or a fluid having luminescent properties.

Where a security feature is designed to be machine-readable, different security features of the same type (different security feature instances of the same security feature class) may be readable by the same machine.

The security feature may be overt or covert. The security feature may be human readable, machine readable, or both.

Selecting one of a plurality of different security features may be implemented by selecting from a prepared batch of different security features of the same type (or class).

The method may include the further step of providing security features as labels on a holder, such as a roll or sheet. For example, there may be a roll or sheet of labels, each label having a security feature. Not every security feature needs to be different to all other security features of that type; for example, every nth label may be identical, so that there may only be n different security features of that type. For example, the type of security feature may be a luminophore, and there may be ten different security features, each with a unique luminescence signature. Thus, a sheet of labels may have multiple identical security features on the sheet.

Where labels are used, the labels may be transparent to allow the labels to be affixed on top of, and in registration with, the code. Where the security feature is invisible to the human eye (a covert feature), and the code is visible to the human eye, this allows an operator of a security feature reader to locate the security feature by locating the code.

Applying the selected security feature to the item to create a tagged item may be implemented by removing the selected security feature from the holder and adhering the label to the item to be tagged.

A label may be releasably mounted on a backing sheet or may be applied by heat treatment, chemical treatment, or the like.

The label may be coated on an underside with pressure-sensitive adhesive. The pressure-sensitive adhesive may be transparent. The label may be tamper evident to indicate if an attempt has been made to remove the label once it has been adhered to the item to be tagged. The label may include frangible portions that tear if an attempt is made to remove the label from the item to be tagged, thereby rendering the label useless for subsequent use.

Associating the identified code with the selected security feature in an authentication database may comprise communicating details of the security feature and details of the code to a remote data management system. This may be performed by a security feature reader.

The remote data management system may create an entry for that item using the code as an index for that entry.

Associating the identified code with the selected security feature may further comprise reading both the code and the security feature using the security feature reader.

The security feature reader may include a barcode reader and a security feature reader.

According to a second aspect of the present invention there is provided a system for tagging items with a security feature, the system comprising: a secure reader for reading both a unique code on an item and a security feature applied to the item; a batch of security features for individual application to the item to tag the item; a database for storing for each tagged item details of the unique code and the security feature for that tagged item.

The unique code may be a spatial code, such as a barcode.

The batch of security features may be provided as a sheet of labels, a roll of labels, or the like.

The labels may be transparent so that they can be applied over the unique code without obscuring the unique code.

The labels may be adhesive to allow easy application to the item to be tagged.

Where the security feature is printable, the labels may be printed on demand.

The database may be used to authenticate the tagged item by receiving an authentication request from a reader. The authentication request may include the unique code (or a unique subset thereof) and data read from the security feature. The database may use the unique code to identify a record for the tagged item, and may ascertain if the data read from the security feature corresponds to that stored in the record for that tagged item.

Any convenient security feature may be used, but machine-readable security features will generally provide higher security by removing some human steps in the record creation process for the database.

According to a third aspect of the present invention there is provided a batch of pre-prepared security features for applying to an item having a code differing from a code on an identical item.

The batch may be in the form of a roll, a sheet, or the like.

The security feature type may be a luminophore. The luminophore may be a dye, quantum dots, a silica-based matrix enclosing a luminescent substance, or the like. The 10 luminescent substance enclosed in a silica-based matrix may be one or more lanthanides, quantum dots, dyes, or the like.

Each security feature may be provided on an individual label. The label may be transparent to allow it to be placed over an item's code. The label may have an adhesive side to facilitate application to the item.

There may only be n different security features in a batch. The security features may be repeated after n occurrences, or they may be randomly disposed in a batch.

A first batch may comprise a plurality of labels, each label carrying an identical security feature. A second batch, for use after the first batch, may also contain a plurality of labels, each label carrying an identical security feature, but the security features of the second batch may be of the same type but different to those of the first batch. This may be used when a manufacturer desires to distinguish items manufactured at different times, for example, on different days.

According to a fourth aspect of the present invention there is provided a method of recording an association between an item and a security feature applied to that item, the method comprising: receiving an association request comprising information about a code applied to a tagged item and information about a security feature applied to the tagged item; validating the association request; and creating an entry for the tagged item in the event that the association request is validated, the entry comprising information about the tagged item and information about the security feature applied to the tagged item.

The step of creating an entry for the tagged item may include indexing the entry using information about the tagged item.

Validating the association request may include validating that the association request relates to an item previously registered but not previously associated.

Validating the association request may include validating that the association request was transmitted by a secure reader.

The information about the item may uniquely identify the item. The information about the item may include details about the type of item that has been tagged.

The created entry may include or reference information about secure readers permitted to request authentication of the tagged item.

The method may include the further steps of receiving an authentication request comprising information about a tagged item and information about a security feature applied to the tagged item, comparing the authentication request with the created entry to ascertain if the tagged item is authentic, and validating the authentication request in the event of a match.

According to a fifth aspect of the invention there is provided an authentication database for recording an association between an item and a security feature applied to that item to tag the item for subsequent authentication thereof, the database comprising: an interface which receives an association request comprising information about a code applied to a tagged item and information about a security feature applied to the tagged item; and an authenticator which is operable to (i) validate the association request, and (ii) create an entry for the tagged item in the event that the association request is validated, the entry comprising information about the tagged item and information about the security feature applied to the tagged item.

The database may include a security component. The security component may include a timestamp generator, a transaction identifier counter, and a unique system identification.

The database may include a log file for storing details of failed authentications. The log file may store details of every authentication attempt, whether successful or unsuccessful. This data may be used to generate reports, or for track and trace applications that enable an item to be tracked as it moves along a supply or distribution chain.

The authenticator may also be operable to (iii) receive an authentication request comprising information about a tagged item and information about a security feature applied to that tagged item, (iv) identify any created entry including identical information about a tagged item to the information in the authentication request, (v) compare the security feature information in the created entry with the security feature information in the authentication request, and (vi) confirm the authenticity of the tagged item in the event of a match.

According to a sixth aspect of the invention there is provided a batch of pre-prepared labels for applying to an item, each pre-prepared label comprising a spatial code unique to that label, and a security feature differing from a security feature on at least one other pre-prepared label, where the pre-prepared labels are provided for applying to items.

The pre-prepared label may have a spatial code pre-printed thereon, and a security feature applied on demand; alternatively, the pre-prepared label may have a security feature disposed thereon and a spatial code may be printed on the label on demand.

The security feature may comprise a photochromic dye and/or pigment. Photochromic dyes and pigments can be used to provide an invisible barcode that becomes temporarily visible when exposed to UV light. The spatial code can be read, then the security feature can be exposed to UV light and the resulting photochromic barcode can then read by a barcode scanner module. The UV light and the barcode scanning module may be provided in a feature reader. The same feature reader may read both a conventional spatial code (such as a 2D barcode) and a security feature (such as a photochromic barcode).

It will now be appreciated that a system is provided having multiple different security features of the same type, and only one of these security features is applied to each item;

Identical items can be distinguished automatically because each item has a unique code, which can be used as an index to access a database. The database stores details of the particular security feature expected on any given item, so the correct security feature for a particular item (not merely one of the security features used on that type of item) must be provided by a counterfeiter for a counterfeit item to be authenticated. This overcomes the problem of a counterfeiter being able to counterfeit items without restriction if the security feature is compromised. Even if all of the security features are compromised, the counterfeiter must still discover, on an item by item basis, which one of these security features is used on each particular item.

These and other aspects of the invention will now be described, by way of example, with reference to the accompanying drawings.

### BRIEF DESCRIPTION OF THE DRAWINGS

In the accompanying drawings:

FIG. 1 is a schematic diagram of a tagging system according to one embodiment of the present invention;

FIG. 2 is a pictorial diagram showing a part (a security feature label) of the tagging system in more detail;

FIG. 3 is a schematic diagram illustrating a part (a secure reader) of the tagging system of FIG. 1 in more detail;

FIG. 4 is a block diagram illustrating a part (a read engine) of the secure reader of FIG. 3 in more detail;

FIG. 5 is a block diagram illustrating another part (a security module) of the secure reader of FIG. 3 in more detail;

FIG. 6 is a block diagram illustrating a part (a remote database) of the tagging system of FIG. 1 in more detail;

FIG. 7A is a bock diagram illustrating a data structure of a typical entry in the remote database of FIG. 6;

FIG. 7B is a bock diagram illustrating a data structure of a master entry in the remote database of FIG. 6;

FIG. 7C is a bock diagram illustrating a data structure of an item record entry in the remote database of FIG. 6;

FIG. 8 is a flowchart illustrating the steps involved in creating individual entries in the remote database of FIG. 6;

FIG. 8B is diagram illustrating the security feature label of FIG. 2 applied to an item;

FIG. 9A is a diagram illustrating the format of a new entry request packet sent from the secure reader of FIG. 3 to the remote database of FIG. 6;

FIG. 9B is a diagram illustrating the format of data packets sent with a new entry request packet from the secure reader of FIG. 3 to the remote database of FIG. 6;

FIG. 10 is a schematic diagram of an authentication system for authenticating an item tagged by the tagging system of FIG. 1;

FIG. 11 is a flowchart illustrating the steps involved in authenticating an item (a microprocessor) using the data management system of FIG. 1;

FIG. 12 is a diagram illustrating the format of an authentication request transmitted within the authentication system of FIG. 10; and

FIG. 13 is a diagram illustrating the format of an authenticity confirmation sent in response to the authentication request of FIG. 12.

### DETAILED DESCRIPTION

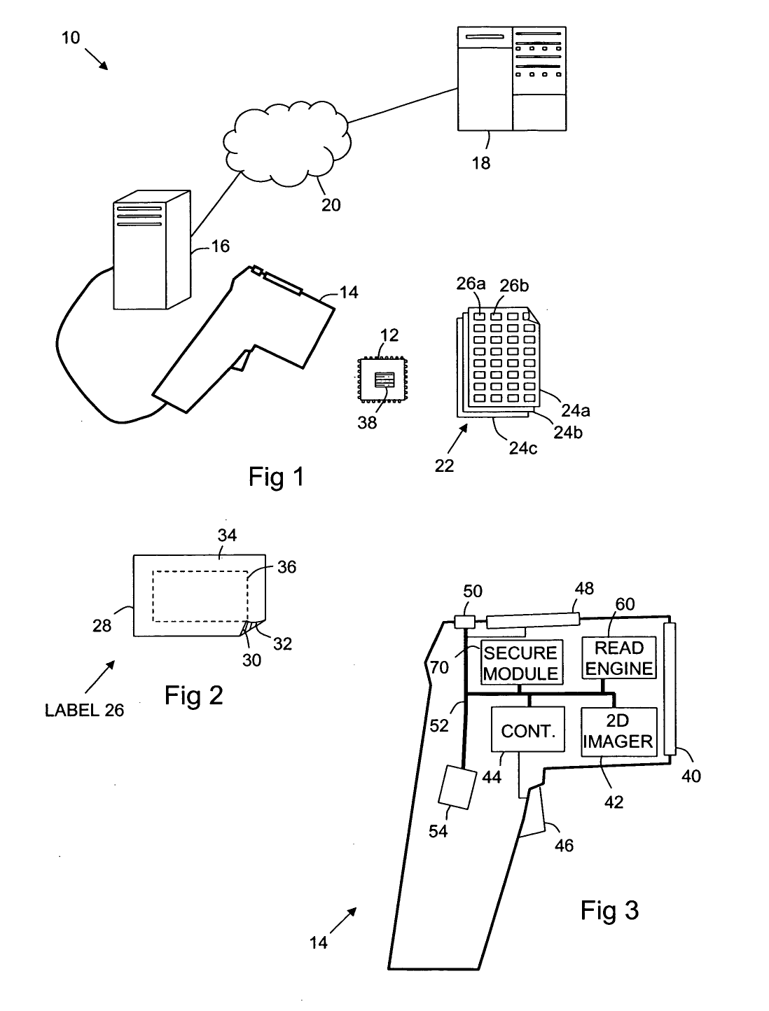

Reference is first made to FIG. 1, which is a schematic diagram of a tagging system 10 according to one embodiment of the present invention. The tagging system 10 is used for tagging items 12 (in this embodiment, a microprocessor) with a security feature so that the authenticity of those items 12 can be verified at some later time.

The tagging system 10 comprises: a secure reader 14, a computer 16 coupled to the secure reader 14, and a remote database 18 coupled to the computer 16 by a network 20. A batch 22 of security features is provided for use with the tagging system 10.

The Security Feature

Reference will now also be made to FIG. 2, which is a pictorial diagram showing the security feature batch 22 in more detail.

The type of security feature used in this embodiment includes multiple small particles of a silica (or glass) host doped with one or more rare earth ions (referred to herein as “RE doped silica”). Details of how to manufacture this type of security feature are provided in U.S. Pat. No. 7,129,506 to Ross et al, entitled “Optically Detectable Security Feature,” and US patent application number 2005/0143249, entitled “Security Labels which are Difficult to Counterfeit”, both of which are incorporated herein by reference. This class of security feature (RE doped silica) includes many different instances of security features (for example, europium-doped silica, dysprosium-doped silica, samarium-doped silica, combinations of these, and such like).

An RE doped silica security feature has a luminescence signature that depends on various parameters, such as: the amount of rare earth dopant, the manufacturing process parameters, the types of rare earth dopants, and such like. It is theoretically possible to produce over one hundred million different luminescence signatures using RE doped silica, which corresponds to over one hundred million different security features of the RE doped silica type of security feature.

As used herein, a luminescence signature refers to aspects of luminescence from a security feature that are unique to that security feature. These aspects may include one or more of: presence or absence of emission at one or more wavelengths; presence or absence of a peak in emission at one or more wavelengths; the number of emission peaks within all or a portion of the electromagnetic spectrum comprising, for example, ultraviolet radiation to infrared radiation (e.g., approximately 10 nm to 1 mm); rate of change of emission versus wavelength, and additional derivatives thereof; rate of change of emission versus time, and additional derivatives thereof; absolute or relative intensity of emission at one or more wavelengths; ratio of an intensity of one emission peak to an intensity of another emission peak or other emission peaks; the shape of an emission peak; the width of an emission peak; or such like.

The security feature batch 22 comprises a plurality of sheets 24a, b, c, . . . m. Each sheet 24 comprising a plurality of security feature labels 26a, b, . . . n releasably mounted on the sheet 24. For illustration purposes, only three sheets 24 and thirty-two labels 26 are shown in FIG. 1, but a security feature batch 22 may comprise many more sheets 24 and labels 26 than are illustrated in FIG. 1.

As best seen in FIG. 2, each security feature label 26 comprises a transparent carrier 28 having a lower surface 30 covered with a layer of transparent, pressure-sensitive adhesive (illustrated by hatching 32), and an upper surface 34 on which is disposed an RE doped silica security feature (illustrated in FIG. 2 by box 36) invisible to the human eye. In this embodiment, the security feature comprise RE doped silica particles suspended in an optically transparent ink printed on the upper surface 34 of the label 26.

The Microprocessor

The microprocessor 12 includes a 2D (two dimensional) barcode 38 laser etched onto its upper surface. The 2D barcode stores a large amount of information, which allows the microprocessor manufacturer to provide serialized parts, that is, each microprocessor 12 has its own unique serial number. Thus, each microprocessor manufactured can be uniquely identified by its 2D barcode.

The 2D barcode 38 can be read by conventional 2D barcode readers. The 2D barcode 38 provides a registration area over which a security feature label 26 can be mounted, as will be described in more detail below. The security feature label 26 is dimensioned to be approximately the same size as the 2D barcode 38.

The Secure Reader

Reference will also now be made to FIGS. 3 to 5, which are diagrams showing the secure reader 14, and parts thereof, in more detail.

The secure reader 14 comprises a combined barcode reader and security feature reader. The secure reader 14 is a modified conventional 2D barcode scanner, such as a barcode reader available from Symbol Technologies, Inc. (trademark) or Metrologic Instruments, Inc. (trademark).

The secure reader 14 comprises: a scanning window 40; a conventional 2D barcode imager 42 aligned with the scanning window 40; associated control electronics 44 for activating the conventional imager 42 (in response to a user depressing a trigger 46) and processing data received from the imager 42; an LCD panel 48 for outputting information to the user (such as information from the 2D barcode 38, the status of the secure reader 14, and such like); a function button 50 for controlling the function of the secure reader 14; internal connections 52 for interconnecting the various components within the secure reader 14; a communications module 54 (including a unique hardware identification in the form of a MAC address) implementing communications with the computer 16; a security feature read engine 60 for reading a security feature 26 carried by a microprocessor 12; and a security module 70 coupled to the security feature read engine 60.

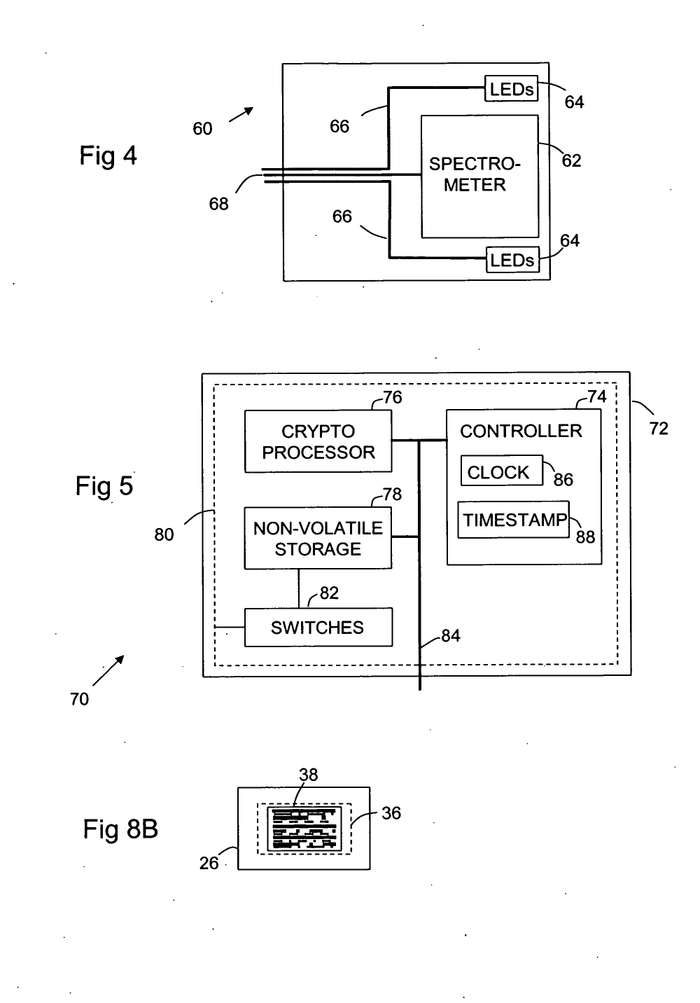

The read engine 60 (best seen in FIG. 4, which is a block diagram illustrating the read engine 60 in more detail) includes a spectrometer 62 for detecting luminescence in the visible and near infra-red regions of the electromagnetic spectrum, and an excitation source 64 in the form of LEDs disposed on opposing sides of the spectrometer 62 and emitting in the ultra-violet region of the electromagnetic spectrum. The LEDs 64 are coupled to the security module 70 by power lines 66, and the spectrometer 62 is coupled to the security module 70 by power and data lines 68.

The security module 70 (best seen in FIG. 5, which is a block diagram illustrating the security module 70 in more detail) comprises a sealed housing 72 in which the following components are mounted: control electronics 74 for driving the security feature read engine 60 and for processing data received therefrom; a conventional cryptographic processor 76 to support encrypted communication with the computer 16; non-volatile storage 78 for storing encryption keys and/or encryption algorithms; a security membrane 80 (illustrated by a broken line in FIG. 5) disposed around an inside surface of the housing 72 and coupled to tamper switches 82 that activate an erase line of the non-volatile storage 78 when the membrane 80 is penetrated or disturbed, thereby destroying any stored encryption data (such as keys, algorithms, or such like) in the event that the security module 70 is tampered with. An internal bus arrangement 84 is also provided to facilitate communications within the housing 72, and a communication adapter 86 is provided to facilitate communications between the security module 70 and the other components of the secure reader 14.

The control electronics 74 includes a clock 86, and a timestamp generator 88 that maintains a timer using an offset from a known base, incremented by ticks based on the clock 86.

The Remote Database

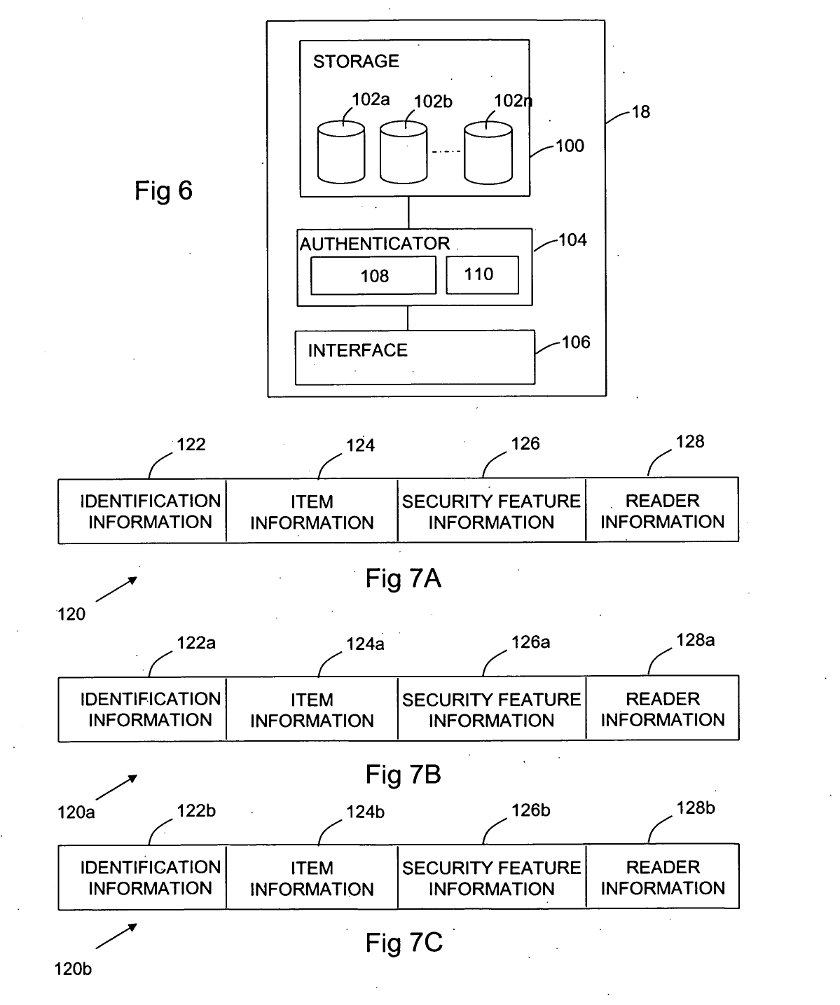

Reference will now also be made to FIG. 6, which is a block diagram illustrating the remote database 18 in more detail, and to FIG. 7A, which is a bock diagram illustrating a data structure of a typical entry in the remote database 18. The remote database 18 comprises: a data store 100 including a plurality of storage areas 102a, b, . . . each storage area 102 having the capacity to store a large number of data entries; an authenticator 104 for accessing the data store 100 to authenticate requests received from the secure reader 14; and a secure reader interface 106 for receiving authentication requests from, and transmitting response to, the secure reader 14.

The authenticator 104 also includes: a security component 108 including a timestamp generator, a transaction identifier counter, and a unique system identification; and a log file 110 for storing details of failed authentications.

A typical data entry (an item record) stored in storage area 102 has the format shown in FIG. 7A. The item record 120 comprises four main categories of information: customer identification information 122, item information 124, security feature information 126, and secure reader information 128.

The customer identification information 122 includes fields for a global customer identification and for a UCC Company Prefix from a 2D barcode. The global customer identification is assigned by the issuer of the security features (who may be the owner of the data management system 10). The global customer identification is unique for each customer. The security feature issuer issues the security feature batch 22 to the customer. The customer identification information may include additional fields not listed herein.

The item information 124 includes fields for a description of the item, a serial number and/or part number of the item, a location where the item is manufactured and/or distributed, and information from a barcode on the item. The description of the item may include the item name (for example, a brand name), the item type (a microprocessor), item specifications (processing speed), and such like. Additional or different fields may be provided depending on the particular item, the application and/or industry that item will be used in, and the value of that item.

The security feature information 126 includes fields indicating the type of security feature (optical, magnetic, radio-frequency, or such like) if more than one type of security feature is in use, and data representing the security feature. The data representing the security feature may be raw data, or some transformation of the raw data. In this embodiment, the security features used are optical, and the data representing the security feature is raw data relating to the intensity of each point of interest and information about the wavelength range and increment, so that the luminescence intensity at known wavelengths can be ascertained.

The secure reader information 128 includes fields indicating the identity and/or location of those readers that are permitted to request authentication of the item listed in the item information 124.

Initial Customer Registration

Prior to using the system, a customer is registered and customer entries are created. This involves the security feature issuer (i) assigning a global customer identification to the customer, (ii) creating entries in the remote database 18 for the customer (new customer entries), and (iii) providing the customer with a security feature batch 22.

The security feature batch 22 has n different security features, where n is a relatively low number (between five and fifteen) if medium level security is required, and n is a relatively high number (over fifty) if high level security is required. Typically, the higher the value of n the more the customer has to pay for the batch 22. In this example, n is ten. The batch contains tens of thousands of security feature labels 26, but each of these security feature labels 26 has one of ten (the value of n in this example) different luminescence signatures.

Although the data format shown in FIG. 7A illustrates the type of information stored for the item 12, it does not reflect the way the database 18 implements storage of this information. In particular, since there are only ten (n) different luminescence signatures, it is not efficient to replicate this information in tens of thousands of entries. Instead, the database 18 stores the ten different luminescence signatures in one area in a master entry, and the database 18 includes a pointer in each item record that points to the correct one of these ten luminescence signatures for that item. These ten different luminescence signatures can be stored in the database 18 when the customer is registered.

When the issuer creates new entries in the database 18 for the customer, the issuer creates a master entry 120a (illustrated in FIG. 7B), and populates the master entry 120a with appropriate information. The master entry 120a includes information that is common to all of the items to be tagged and has the same format as the item record 120. Any information specific to one item (for example, a serial number) will be added to specific entries under the master entry 120a.

In this example, the issuer populates the customer identification information 122a with the global customer identification.

The issuer may populate the item information 124a with details provided by the customer, or this may be populated automatically, as described below.

The issuer populates the security feature information 126a with details of the security features provided in the batch 22, that is, the ten (n) different security features provided to the customer by the issuer. The issuer populates the security feature information 126a with the actual luminescence signatures of each of the ten (n) different security features. Each of these ten different security features has its own field that can be pointed to uniquely by an individual item record.

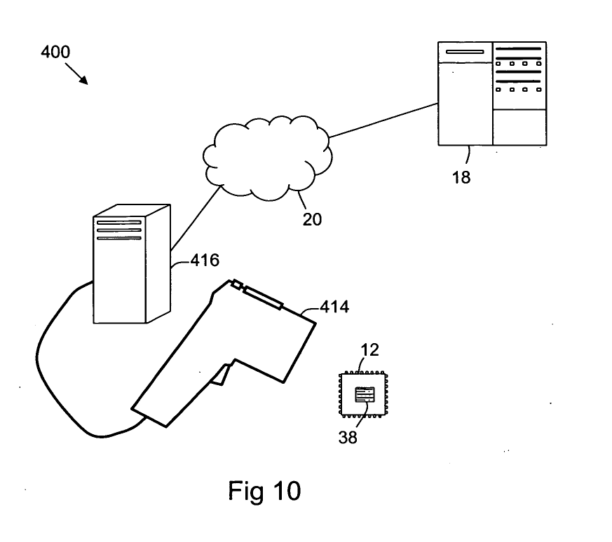

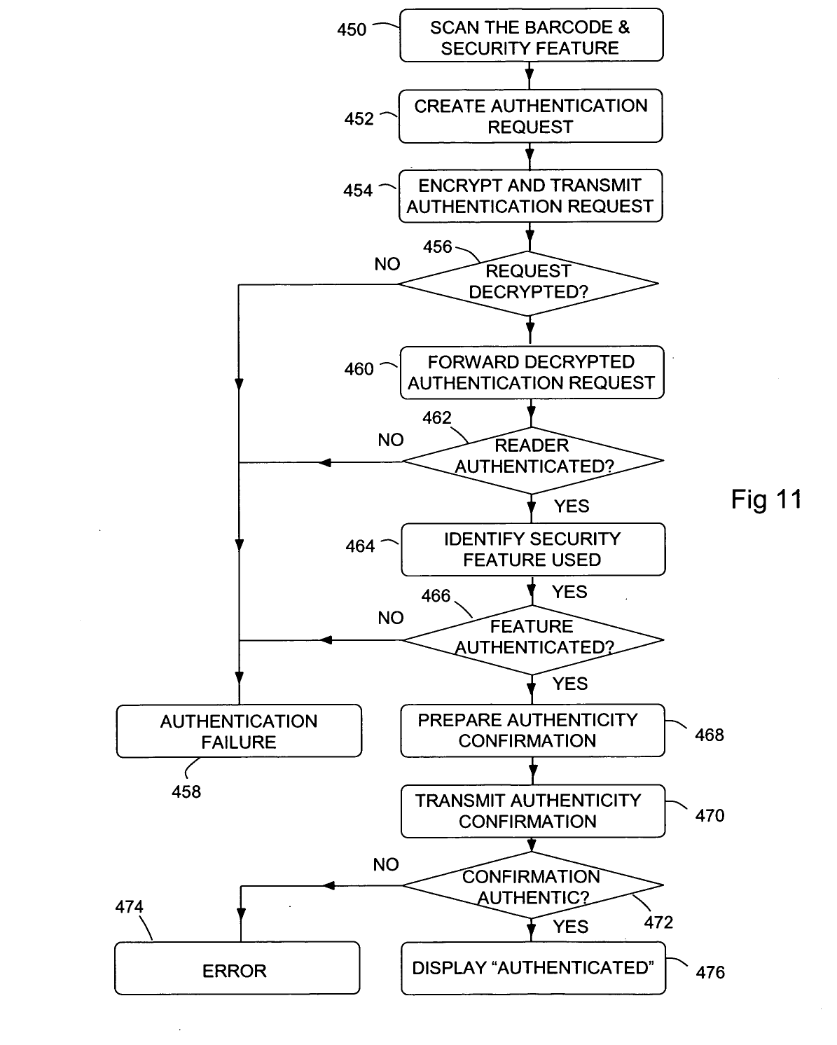

The issuer populates the secure reader information 128a with the MAC addresses of the secure readers 14 (from the communications module 54 in the secure readers 14), and of any other secure readers (as described below with reference to FIG. 10) that will be used. When this has been completed, the master entry 120a is complete.

Operation of Tagging System

There are two main modes of operation of the tagging system 10. The first mode is to create individual item records (the new customer entries) under the master entry 120a; the second mode is to authenticate an item (such as microprocessor 12) referenced by an individual item record. These operations will be described in turn.

Creating Individual Item Records

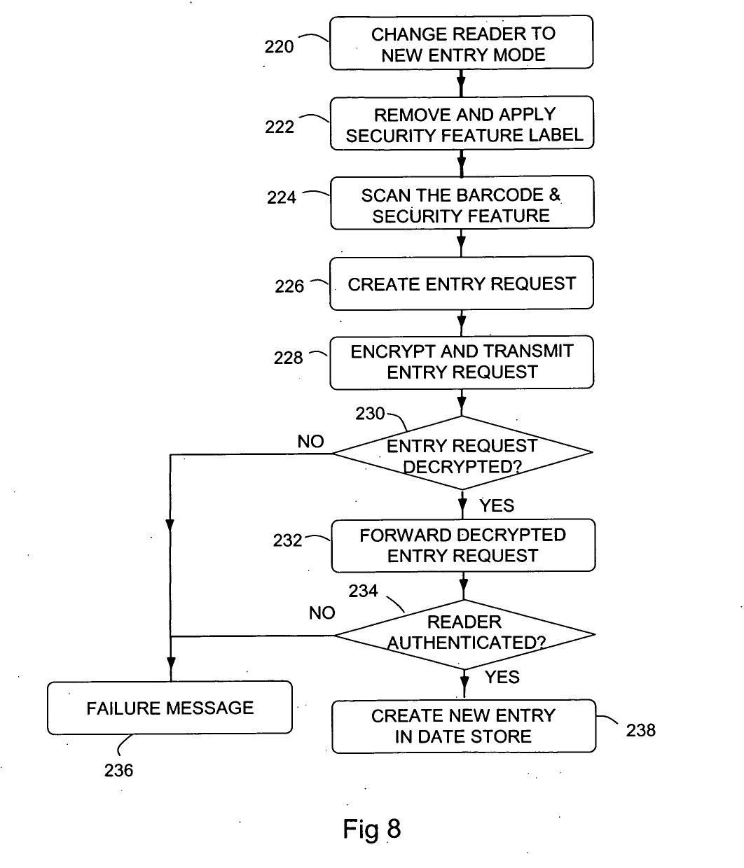

Once the master entry 120a has been created by the issuer, the customer then creates individual item records 120b (illustrated in FIG. 7C) under the master record for that item. This will now be described with reference to FIG. 8, which is a flowchart illustrating the steps involved in creating individual item records under the master record for microprocessors 12.

There will be an individual item record 120b for each microprocessor 12 because each microprocessor 12 that is manufactured will be associated with one of ten different luminescence signatures. This means that the database 18 will store hundreds of thousands or millions of entries for that type of microprocessor 12.

The first step is to change the mode of the secure reader 14 to entry creation mode (step 220). This is performed by a user pressing the function button 50 repeatedly (thereby toggling through different modes) until the LCD panel 48 displays “New Entry”.

The user then peels off a label 26 from a sheet 24 in the batch 22, and adheres the peeled label 26 to the microprocessor 12 on top of the 2D barcode 38 (step 222), shown in more detail in FIG. 8B.

Once in entry creation mode, the user scans the 2D barcode 38 on the microprocessor 12 by aligning the scanning window 40 with the barcode 38 and depressing the trigger 46 (step 224). This causes the 2D barcode imager 42 and associated control electronics 44 to scan and decode the barcode 38, and the read engine 60 and security module 70 to read and decode the security feature 36 on the newly-applied label 26.

Once the barcode 38 and security feature 36 have been read, the security module 70 then creates a new entry request (step 226). A new entry request informs the database 18 about data from a security feature 36 and data from the 2D barcode 38 on an item tagged by that security feature 36. This will provide the database 18 with the unique serial number of a particular microprocessor 12 and the luminescence signature identifying which security feature 36 has been applied to that microprocessor 12.

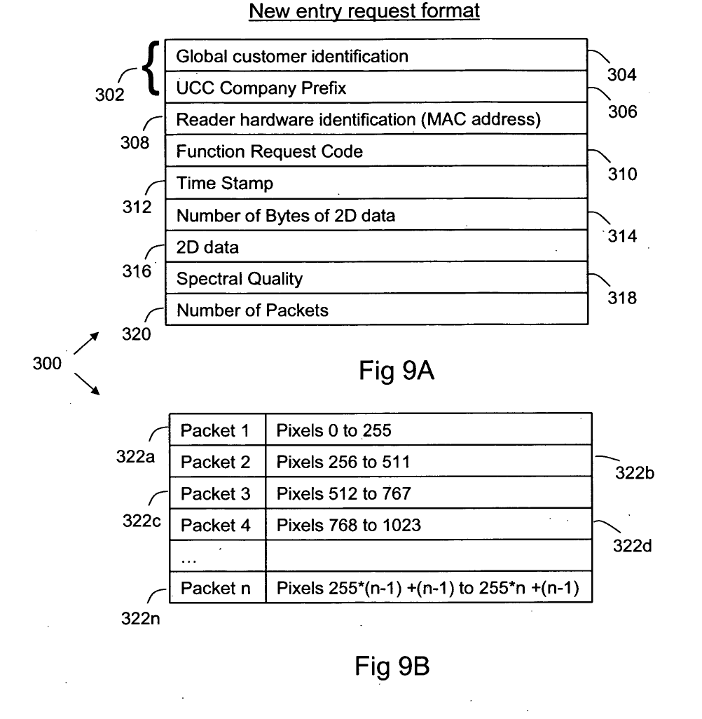

To create the new entry request, the security module 70 constructs a new entry request packet and data packets having the formats shown in FIGS. 9A and 9B respectively. The new entry request 300 comprises: customer identification information 302 (in FIG. 9A this is provided by a global customer identification field 3.04 and a UCC Company Prefix field 306), reader identification information 308 (in the form of a MAC address), function request information 310 (in the form of a code indicating that the request is an association request), timestamp information 312 (generated by the timestamp generator 88 in the control electronics 74), barcode data size information 314 indicating the number of bytes of 2D barcode data that will be included in the new entry request 300, barcode data 316 (obtained during the scanning step 224), spectral quality information 318 indicating the number of pixels covered by each data packet, packet number information 320 indicating the number of data packets to follow, and actual data packets 322a to 322n corresponding to the packet number information 320. The actual data packets may be transmitted separately from fields 302 to 320 for more efficient communication.

The actual data packets 322 contain the security feature spectral information read during the scanning step 224. In this embodiment, each data packet 322 contains 256 pixels, and there are sixteen data packets, which results in 4096 pixels for the security feature spectrum. The luminescence signature may comprise the security feature spectrum, or the luminescence signature may be a portion of the security feature spectrum or a transformation of the security feature spectrum.

Once the security module 70 has populated the new entry request 300 with the relevant data, the next step is for the security module 70 to encrypt and transmit the new entry request 300 to the secure reader interface 106 in the remote database 18 (step 228) via the computer 16 and network 20. Multiple secure readers 14 may be coupled to the computer 16, which can act as a concentrator that connects individual readers 14 to the remote database 18.

On receipt of this encrypted entry request 300, the secure reader interface 106 attempts to decrypt the request 300 (step 230). If the new entry request 300 cannot be decrypted then the secure reader interface 106 responds to the secure reader 14 with a failure message (step 236), and updates the log file 110 with details of the failed request. If the new entry request 300 is correctly decrypted, then the secure reader interface 106 conveys the decrypted new entry request 300 to the authenticator 104 (step 232).

The authenticator 104 parses the new entry request 300 to authenticate the reader 14 that sent the message (step 234). This involves extracting the MAC address of the secure reader 14 from the reader identification information 308 and comparing it with the MAC addresses stored in the secure reader information 128a of the master record 120a in the database 18. If there is a match then the MAC address corresponds to that of a permitted secure reader 14, indicating that the secure reader 14 is owned or operated by (or under the authority of) the customer.

If the reader authentication step (step 234) is not successful, then the authenticator 104 conveys a failure message to the security module 70 via the secure reader interface 106 and the computer 16 (step 236). The authenticator 104 also updates the log file 110 with details of the failed request.

The authenticator 104 also compares the timestamp information 312 with previous timestamps to ensure that it is subsequent to a timestamp previously received from that secure reader 14.

If the reader authentication step (step 234) is successful, then the authenticator 104 creates a new entry 120b in the database 18 under the master entry 120a for that customer (step 238).

The new entry 120b includes the UCC Company Prefix in the customer identification information 122b, which is obtained from the barcode data 316 in the new entry request 300. The new entry 120b also includes all or some of the barcode data 316. If only some of the barcode data 316 is stored, then the serial number of the microprocessor 12 will typically be stored, and optionally a hash of the entire 2D barcode data 316.

The authenticator 104 analyzes the data packets 322 to ascertain which of the ten (n) different luminescence signatures has been conveyed. The authenticator 104 then creates a link in the security feature information 126b of the new entry 120b to the appropriate luminescence signature in the security feature information 126a of the master entry 120a. Thus, the security feature information 126b in the new entry 120b comprises a link field 126b.

When the new entry 120b has been created under the master entry 120a, the authenticator 104 conveys a message to the secure reader 14 (via the secure reader interface 106, the network 20, and the computer 16) indicating that the new item record 120b was created successfully. The secure reader 14 informs the user of successful record creation via the LCD panel 48.

The user can then repeat the process for the next microprocessor 12.

Authenticating an Item

When a microprocessor 12 has been tagged with a label 26 and a new entry 120b for the tagged microprocessor has been created in the database 18, the microprocessor 12 can then be shipped to a distributor or an end user (referred to herein as the “purchaser”).

When the purchaser receives the tagged microprocessor 12, the purchaser can then authenticate the tagged microprocessors 12 using an authentication system, as shown in FIG. 10. This authentication system 400 is very similar to tagging system 10 (tagging system 10 can also be used as an authentication system).

The authentication system 400 comprises: a secure reader 414, a computer 416 coupled to the secure reader 414, and the remote database 18 coupled to the computer 416 by the network 20. The secure reader 414 is very similar to the secure reader 14, the primary difference being that the secure reader 414 is only operable in one mode (authentication) and does not have a function button 50. Secure reader 14 operates in either entry creation mode or authentication mode. In almost every other respect, the secure reader 14 is identical to the secure reader 414.

When the purchaser receives a consignment of microprocessors. 12, the purchaser can authenticate a tagged microprocessor 12 using the process illustrated in FIG. 11, which is a flowchart illustrating the steps involved in authenticating a tagged microprocessor 12.

The purchaser aligns the secure reader 414 with the tagged microprocessor 12 and scans the 2D barcode 38 on the microprocessor 12 (step 450) in a similar way to that described with reference to step 224 of FIG. 8. This causes the secure reader 414 to scan and decode the barcode 38 and to read and decode the security feature 36.

Once the barcode 38 and security feature 36 have been read, the secure reader 414 then creates an authentication request (step 452) using the data read from the barcode 38 (the UCC Company Prefix, and the complete barcode data) and the data read from the security feature 36 (wavelength and intensity information). The authentication request conveys data about the security feature 36 to the database 18.

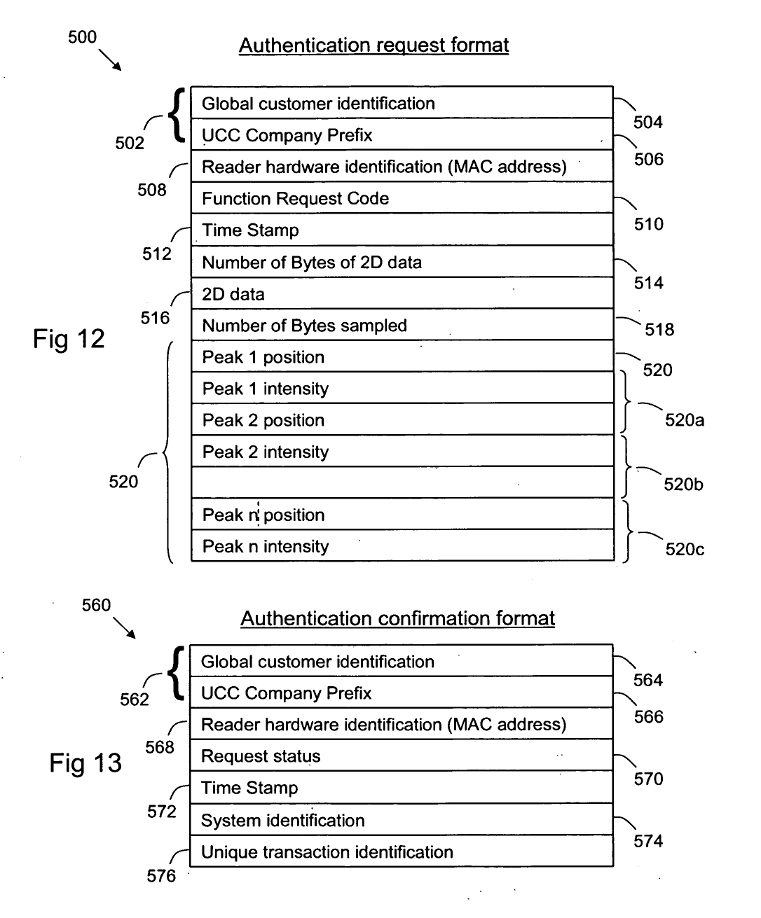

To create the authentication request, the security module 70 constructs a request packet having the format shown in FIG. 12.

The authentication request 500 comprises: customer identification information 502 (provided by a global customer identification field 504 and a UCC Company Prefix field 506), reader identification information 508 (in the form of a MAC address), function request information 510 (in the form of a code indicating that the request is an authentication request 500), timestamp information 512, barcode data size information 514 indicating the number of bytes of 2D barcode data that will be included in the authentication request 500, barcode data 516 (obtained during the scanning step 450), a sample size field 518 that indicates the number of bytes sampled (that is, the number of pairs of fields to follow), and pairs of data points fields 520a, b, . . . n. Each pair of fields 520 containing a peak position and its associated intensity, with the number of data points fields 520 being indicated by the sample size field 516. The pairs of data points fields 520 may be transmitted with fields 502 to 518, or may be transmitted separately from fields 502 to 518 for more efficient communication.

The pairs of data points fields 520 contain portions of, or derived from, the security feature spectral information read during the scanning step 450.

Once the security reader 414 has populated the authentication request 500 with the relevant data, the next step is for the security reader 414 to encrypt and transmit the authentication request 500 to the secure reader interface 106 in the database 18 (step 454).

On receipt of this encrypted authentication request, the secure reader interface 106 decrypts the request 500 (step 456). If the authentication request 500 cannot be decrypted then the secure reader interface 106 responds to the secure reader 414 with a failure message (step 458), and updates the log file 110 with details of the failed request. If the authentication request 500 is correctly decrypted, then the secure reader interface 106 conveys the decrypted authentication request 500 to the authenticator 104 (step 460).

The authenticator 104 then attempts to authenticate the secure reader 414 (step 462) by parsing the authentication request 500 in a similar way to that described with reference to step 234 of FIG. 8; namely, the authenticator 104 ascertains if the MAC address of the secure reader 414 corresponds to that of a permitted reader, and if so, if the permitted reader is owned or operated by (or under the authority of) the customer.

If the reader authentication step (step 462) is not successful (for example, because the MAC is not present, or present but not correct, or because the global identification in the request is not a recognized global identification, or because it is a recognized global identification but does not correspond to the global identification associated with that MAC address), then the authenticator 104 conveys a failure message to the secure reader 414 via the secure reader interface 106, the network 20, and the computer 416 (step 458), and updates the log file 110 with details of the failed request.

If the reader authentication step (step 462) is successful, then the authenticator 104 parses the authentication request 500 to ascertain which of the ten security features 36 has been applied to the microprocessor 12 (step 464). The authenticator 104 does this by reading the link field 126b, which identifies the particular security feature used.

The authenticator 104 then authenticates the security feature (step 466) by comparing the luminescence signature of the identified security feature (referenced by link field 126b) with the pairs of data points fields 520a, b, . . . n from the authentication request 500. The authenticator 104 may transform the security feature information stored in the security feature information 126a to create the luminescence signature. The authenticator 104 may also transform the pairs of data points fields 520a, b, . . . n from the authentication request 500 to create the luminescence signature.

If the security feature authentication step (step 466) is not successful, then the authenticator 104 conveys a failure message to the secure reader 414 via the secure reader interface 106, the network 20, and the computer 416 (step 458), and updates the log file 110 with details of the failed request.

If the security feature authentication step (step 466) is successful, then the authenticator 104 prepares an authenticity confirmation for sending to the secure reader 414 that sent the authentication request 500 (step 468).

The authenticity confirmation has the format shown in FIG. 13. The authenticity confirmation 560 comprises: customer identification information 562 (provided by a global customer identification field 564 and a UCC Company Prefix field 566), reader identification information 568 (in the form of a MAC address), request status information 570 (which is set to indicate that the authentication request was successful), timestamp information 572 (generated by the timestamp generator in the security component 108), a system identification field 574 populated by the unique system identification from the security component 108, and a unique transaction identifier field 576 populated by the current value of the transaction identifier counter in the security component 108.

The authenticator 104 then sends the authenticity confirmation 560 to the secure reader 414 via the secure reader interface 106, the network 20, and the computer 416 (step 470).

On receipt of the authenticity confirmation 560, the secure reader 414 authenticates the authenticity confirmation 560 (step 472). It does this by parsing the authenticity confirmation 560 to validate that the system identification is correct and that the value of the timestamp is subsequent to the value of the last timestamp received by the secure reader 414.

If the system identification is not correct, or if the timestamp is not subsequent to the last timestamp received, then the secure reader 414 displays an error message (step 474).

If the authenticity confirmation 560 is authenticated by the secure reader 414, then the secure reader 414 displays the text “Authenticated” (step 476) to the purchaser.

The purchaser can then use the system 400 to authenticate the next tagged microprocessor 12.

A purchaser may only authenticate one in every m microprocessors received, for example, one in every hundred or one in every thousand microprocessors received, as a spot check or as part of a quality assurance program.

The authenticator 104 may record the identity and/or location of the secure reader that issues an authentication request to ascertain if multiple authentication requests are received for the same part from different geographical locations within a short space of time. This may indicate that the part has been compromised by a counterfeiter.

It will now be appreciated that the above embodiment has the advantage that a number of different codes from one type of security feature can be used with an item (for example, a type of microprocessor) so that a counterfeiter must know which code is associated with each instance of that item. This greatly increases the security of the system.

Various modifications may be made to the above described embodiments within the scope of the present invention. For example, in the above embodiment the item to be tagged is a microprocessor; in other embodiments, the item may be a banknote, a component of a machine, a device, a medication, an animal, or the like.

In other embodiments, the security feature batch 22 may be implemented as one or more rolls of labels. The security feature batch 22 may be mounted in a machine that automatically dispenses labels on request.

In other embodiments, the security feature label may be larger or smaller than the 2D barcode.

In other embodiments, a label may include both the security feature and a code, such as a spatial code. The code may be printed on the label and the security feature applied to the label (above or beside the code), or the security feature may be applied to the label and then the code printed on the label (above or beside the security feature). In such embodiments, either the code or the security feature may be pre-printed, and the other part (the security feature or the code, respectively) may be printed on demand.

In other embodiments, the data formats used may be different to those described above.

In other embodiments, the computer 16 may not be used, the readers 14, 414 may be coupled directly to the database 18.

In other embodiments, the security feature data may be stored in the database 18 as pairs of data points, namely, intensity and wavelength for each wavelength of interest.

In other embodiments, the security features used may not be luminescence-based, or they may not be covert security features (for example a spatial code may be used), or they may be covert but not luminescence-based (for example a spatial code printed with photochromic ink), they may not even be optical (for example, they may be ultrasonic or radio-frequency based).

In other embodiments, the database 18 may not store secure reader information 128. For example, where the database 18 is part of a secure, closed system, it may not be advantageous to have an additional layer of security that requires the secure readers to be registered with the database.

In the above embodiment, the database 18 stores the n different luminescence signatures in one area (the master entry), and the database 18 includes a pointer in each item record that points to the correct one of these n luminescence signatures for that item. In other embodiments, each item record may include the luminescence signature. This has advantages where the label production is not uniform, and there are variations between security features that are intended to be identical.

In other embodiments, more than one type of security feature may be used. For example, a luminophore may be used, and an RFID label may be used.

In other embodiments, the security feature may be a photochromic spatial code, such as a photochromic 2D barcode. This would allow a conventional barcode scanner to be modified by adding an LED (or other suitable excitation source) to excite the photochromic barcode prior to reading the excited barcode.

In other embodiments, a master entry may not be created, only individual entries.

It will be appreciated by one of skill in the art that many different types of database schemas may be employed, and the above examples are merely illustrative.

What is claimed is:

1. A method of tagging an item with a security feature, the method comprising:
selecting one of a plurality of different security features from a common type of security feature;
applying the selected security feature to an item to create a tagged item;
identifying a code associated with the tagged item; and
associating the identified code with the selected security feature in an authentication database to ensure that the tagged item is only authenticated if the identified code matches the selected security feature.

2. A method according to claim 1, wherein identifying a code associated with the item to be tagged includes reading a spatial code associated with the item.

3. A method according to claim 2, wherein reading a spatial code associated with the item includes using a combined reader to read both the spatial code and the security feature.

4. A method according to claim 1, wherein selecting one of a plurality of different security features includes selecting from a prepared batch of different security features of the same type.

5. A method according to claim 1, wherein the method includes the further step of providing security features as labels on a holder.

6. A method according to claim 5, wherein applying the selected security feature to an item to create a tagged item comprises removing the selected security feature from the holder and adhering the label to the item to be tagged.

7. A method according to claim 1, wherein associating the identified code with the selected security feature in an authentication database comprises communicating details of the security feature and details of the code to a remote data management system.

8. A system for tagging items with a security feature, the system comprising:
a secure reader for reading both a unique code on an item and a security feature applied to the item;
a batch of security features for individual application to the item to tag the item; and
a database for storing for each tagged item details of the unique code and the security feature for that tagged item.

9. A system according to claim 8, wherein the unique code is a spatial code.

10. A system according to claim 8, wherein the batch of security features comprises a sheet or roll of labels.

11. A system according to claim 8, wherein the security features comprise a luminophore.

12. A system according to claim 10, wherein the labels are transparent so that they can be applied over the unique code without obscuring the unique code.

13. A system according to claim 10, wherein the labels comprise an adhesive surface to facilitate application to the item to be tagged.

14. A system according to claim 8, wherein the database is used to authenticate the tagged item by receiving an authentication request from a secure reader.

15. A batch of pre-prepared security features for applying to an item having a code differing from a code on an identical item.

16. A batch according to claim 15, wherein the batch comprises a roll of labels, each label including a security feature.

17. A batch according to claim 15, wherein the batch comprises a sheet of labels, each label including a security feature.

18. A method of recording an association between an item and a security feature applied to that item, the method comprising:
receiving an association request comprising information about a code applied to a tagged item and information about a security feature applied to the tagged item;
validating the association request; and
creating an entry for the tagged item in the event that the association request is validated, the entry comprising information about the tagged item and information about the security feature applied to the tagged item.

19. A method according to claim 18, wherein creating an entry for the tagged item includes indexing the entry using information about the tagged item.

20. A method according to claim 18, wherein validating the association request includes validating that the association request relates to an item previously registered.

21. A method according to claim 18, wherein the created entry includes or references information about secure readers permitted to request authentication of that tagged item.

22. A method according to claim 21, wherein validating the association request includes validating that the association request was transmitted by a permitted secure reader.

23. A method according to claim 18, wherein the method includes the further steps of:
receiving an authentication request comprising information about a tagged item and information about a security feature applied to the tagged item;
comparing the authentication request with the created entry to ascertain if the tagged item is authentic; and
validating the authentication request in the event of a match.

24. An authentication database for recording an association between an item and a security feature applied to that item to tag the item for subsequent authentication thereof, the database comprising:
an interface which receives an association request comprising information about a code applied to a tagged item and information about a security feature applied to the tagged item; and
an authenticator which is operable to (i) validate the association request, and (ii) create an entry for the tagged item in the event that the association request is validated, the entry comprising information about the tagged item and information about the security feature applied to the tagged item.

25. An authentication database according to claim 24, wherein the database further comprises: a security component.

26. An authentication database according to claim 25, wherein the security component includes a timestamp generator, a transaction identifier counter, and a unique system identification.

27. An authentication database according to claim 24, wherein the database further comprises a log file for storing details of failed authentications.

28. An authentication database according to claim 24, wherein the authenticator is also operable to (iii) receive an authentication request comprising information about a tagged item and information about a security feature applied to that tagged item, (iv) identify any created entry including identical information about a tagged item to the information in the authentication request, (v) compare the security feature information in the created entry with the security feature information in the authentication request, and (vi) confirm the authenticity of the tagged item in the event of a match.

29. A batch of pre-prepared labels for applying to an item, each pre-prepared label comprising a spatial code unique to that label, and a security feature differing from a security feature on at least one other pre-prepared label, where the pre-prepared labels are provided for applying to items.

30. A method according to claim 29, wherein the pre-prepared label has a spatial code pre-printed thereon, and a security feature applied to the label on demand.

31. A method according to claim 29, wherein the pre-prepared label has a security feature disposed thereon and a spatial code printed on the label on demand.

32. A method according to claim 29, wherein the security feature comprises a photochromic spatial code.
